(19) United States
(12) Patent Application Publication
(10) Pub. No.: US 2004/0056464 A1
(43) Pub. Date: Mar. 25, 2004

(54) Vehicle with a sliding roof

(76) Inventors: Francois De Gaillard, Mouilleron en Pareds (FR); Goetz Mussbach, Gauting (DE)

Correspondence Address: NIXON PEABODY, LLP, 401 9TH STREET, NW, SUITE 900, WASINGTON, DC, 20004-2128, US

(21) Appl. No.: 10/450,046

(22) PCT Filed: Aug. 14, 2002
(86) PCT No.: PCT/EP02/09101

(30) Foreign Application Priority Data
Aug. 22, 2001 (DE) 101 40 240.6

(51) Int. Cl. B60R 21/13

(52) U.S. Cl. 280/756

(57) ABSTRACT

The invention relates to a vehicle with a vehicle roof (2), comprising roof longitudinal side members (3), fixed to the car body, a roof opening (6) between the roof longitudinal side members (3) and a cover assembly (7,8), movably mounted on the roof longitudinal side members (3). Said cover assembly (7,8), adapted for optionally closing or at least partially releasing the roof opening (6), can be folded on the rear part when the roof opening (6) is released. According to the invention, a rollover protection system (13) is arranged at the rear end of the passenger compartment behind the seats or rear seats (12). Said rollover protection system preferably comprises a roll bar (18), which is firmly secured to the corresponding roof longitudinal side member (3) at both ends (19, 20) thereof and which is fixed to the car body structure (16) with the cranked middle section (21) thereof.

The invention relates to a motor vehicle, especially a limousine, sedan or coupe, with a vehicle roof with body-mounted lengthwise roof members, with a roof opening between the lengthwise roof members and with a cover arrangement which is supported to be able to move on the lengthwise roof members for selectively closing or at least partially clearing the roof opening, and which enables the cover arrangement to be lowered in the rear area with the roof opening cleared.

Published European Patent Application EP 0 992 384 A2 discloses a motor vehicle in which a front roof part and a rear roof part are movably supported between the lateral lengthwise roof members of a fastback roof in order to selectively close or at least partially clear a large roof opening. The two roof parts can be pushed to the rear onto a fastback window frame with the roof parts arranged on top of one another so that they can be moved into a lowered position together with the fastback window frame, which contains a rear window, so that a large roof opening in the manner of a semi- or quasi-cabriolet is formed. Since the motor vehicle roof does not have any additional transverse stiffening between the two lengthwise roof members, when the vehicle overturns, buckling of the two lengthwise roof members can only be avoided when these lengthwise roof members are formed with high strength and are anchored on the body, for which, however, high material costs and thus also weight are necessary.

The object of the invention is to devise the initially mentioned vehicle in which using simple means, even with the vehicle's overturning, sufficient safety for the vehicle passengers, especially also on the backs seats, is made available.

This object is achieved in the aforementioned motor vehicle as claimed in the invention in that there is a rollover protection means on the back end of the passenger compartment behind the seats or the rear seats. The rollover protection means increases the safety of the vehicle passengers in the case of overturning by its forming a fixed structure around the passenger or passengers. Thus, the safety increases for a motor vehicle which can be called a semi- or quasi-cabriolet based on the roof shape which can be opened. By virtue of the rollover protection means the fixed roof structure with the lengthwise roof members which cannot be lowered, in contrast to a cabriolet, can be built more easily and with lower stability since individual protection in case of a serious accident such as a vehicle's overturning is assumed by the protection means.

Advantageous embodiments of the invention are given in the dependent claims.

The rollover protection means can have at least one rollover protection bar which is located for example behind the seats of a two-seat vehicle or the back seats of a four-seat vehicle and is securely mounted on the body. The protective bar does not necessarily have direct contact with the respective lengthwise roof member, but supports it against undue buckling towards the passengers in a rollover. One such protective bar is formed for example as a U-shaped bar and is supported with its two ends on a structural body part in the area of the hat rest.

In one preferably embodiment, the protective bar is attached on the one hand to a structural body part behind the seats and on the other hand to the lengthwise roof member. Thus, the protective bar has direct contact with the lengthwise roof members and prevents buckling. Here the protective bar can be bent or angled.

Basically there can be one or more protective bars behind the seat or seats.

Another preferred embodiment calls for the protective bar to be securely connected on its two ends to the respective lengthwise roof member and to be attached to the body structure with its elbowed middle part. Thus only one protective bar extends between the two lengthwise roof members and is connected securely to them and at the same time is permanently connected in its middle part to the structural body part. The structural body part is for example transverse bracing in the area of the hat rest.

Another preferred embodiment calls for at least one protective bar to be to extendable from a stored position into its protective position. This prevents any adverse optical effect by a protective means which is located permanently in its active position. The protective bar is mounted for example on its elbowed middle part on a structural body part to be able to swivel around a transverse axis and its two ends are each movably supported on the guide of the respective lengthwise roof member. Feasibly there is a drive means for extending the protective bar into its active position, which executes extension by sensor control and a pyrotechnic drive or a spring force storage device.

When the two lengthwise roof members are formed between their respective front coupling to the apron which runs above the front window and their respective rear coupling to the rear vehicle structure especially in the area of a B column without the connecting structural bracing which is located in the roof surface, there is an especially large uninterrupted roof surface similar to a cabriolet.

Preferably the cover arrangement consists of louvers of a louvered roof and the louvers are especially transparent glass louvers.

Embodiments of different protective means are detailed below with reference to the drawings.

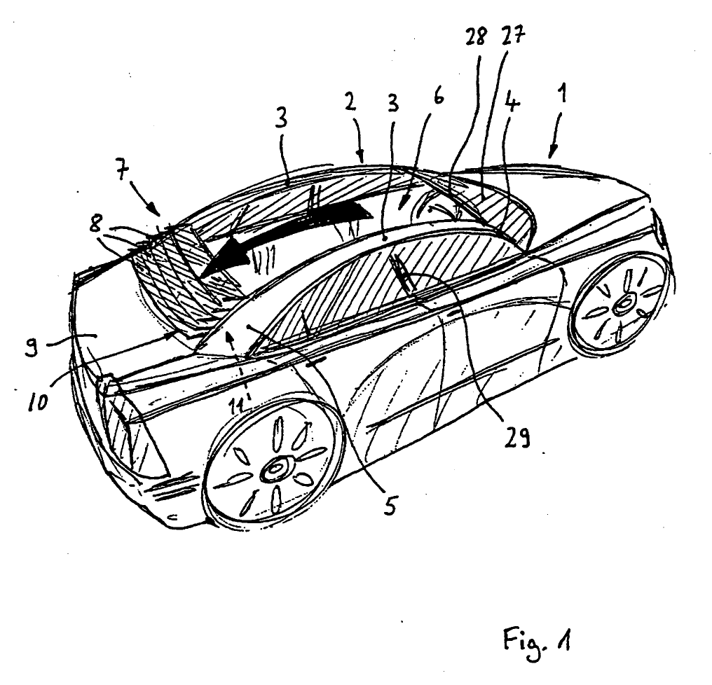

FIG. 1 shows in a perspective overhead view a motor vehicle with a glass louvered roof which is guided on the lengthwise roof members on the two sides in the opened rear deposited position.

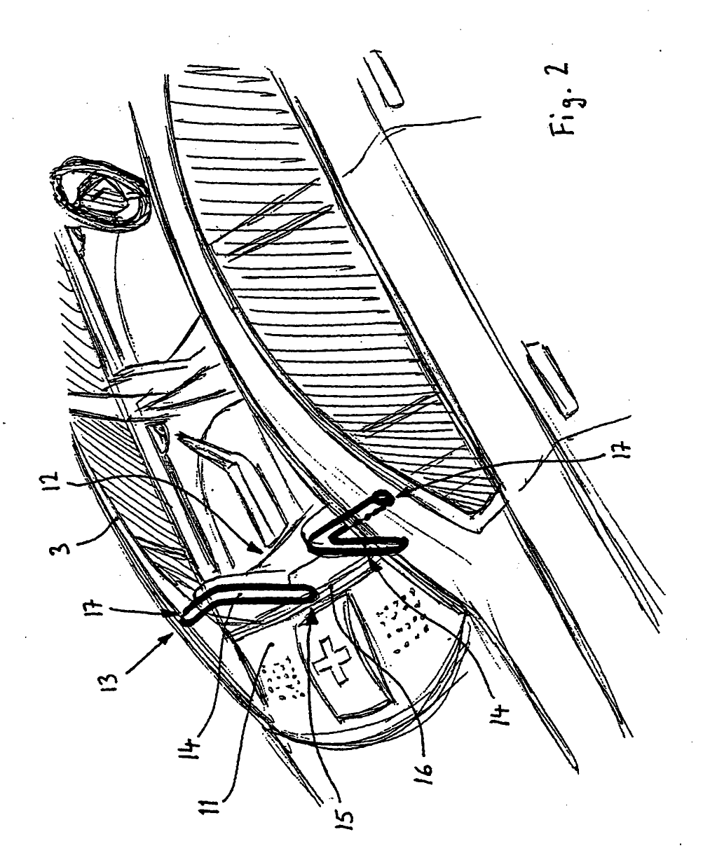

FIG. 2 shows in a perspective overhead view the motor vehicle with a protective means as claimed in the invention;

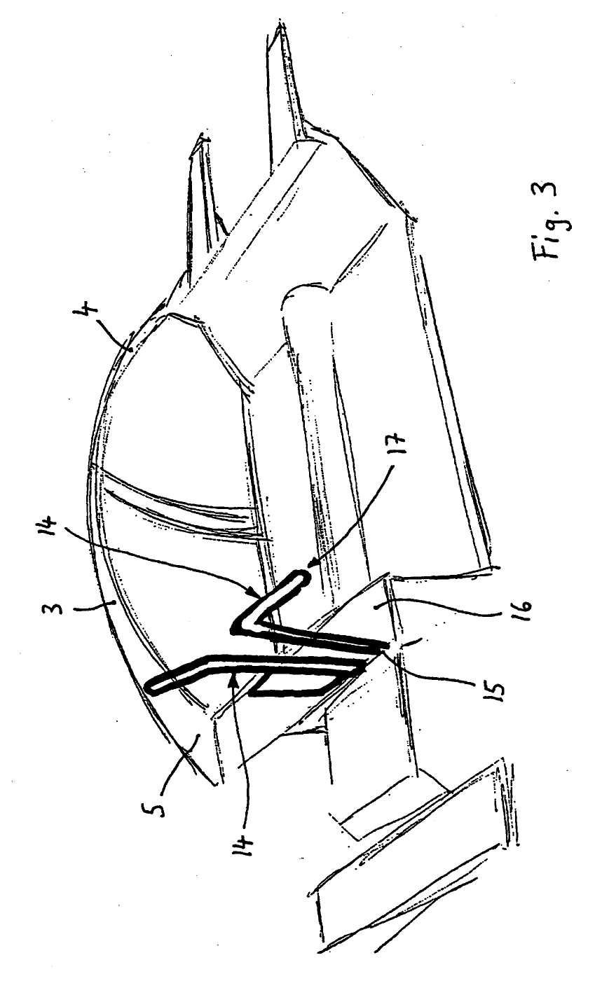

FIG. 3 shows in a perspective overhead view a body structure of the motor vehicle in a partial representation with a protective means attached to it;

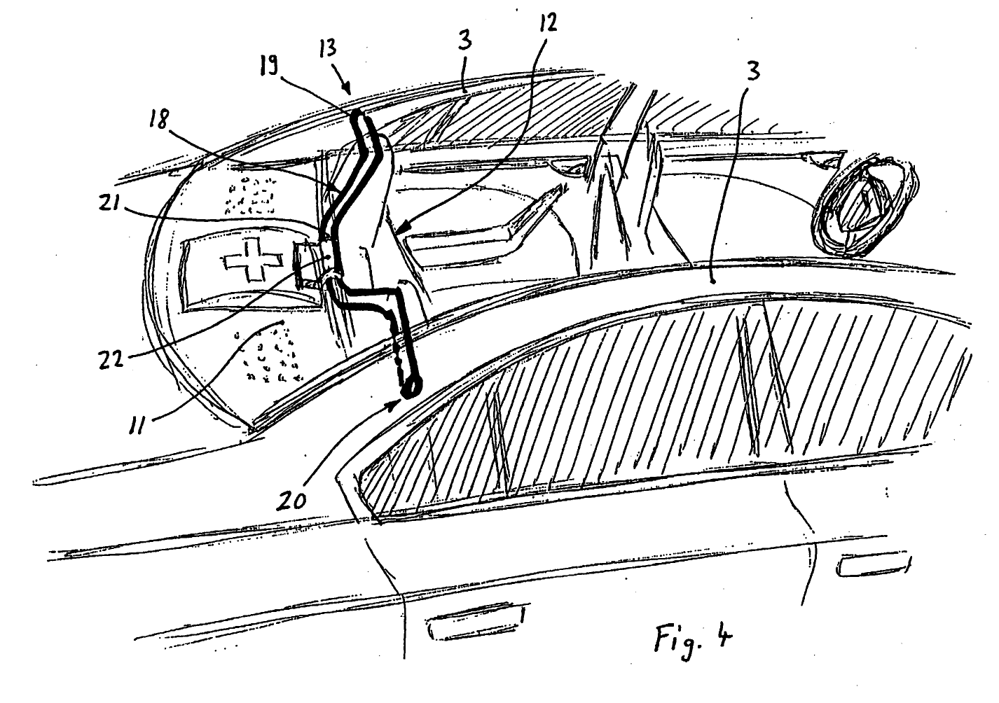

FIG. 4 shows in a view according to FIG. 2 another embodiment of the protective means;

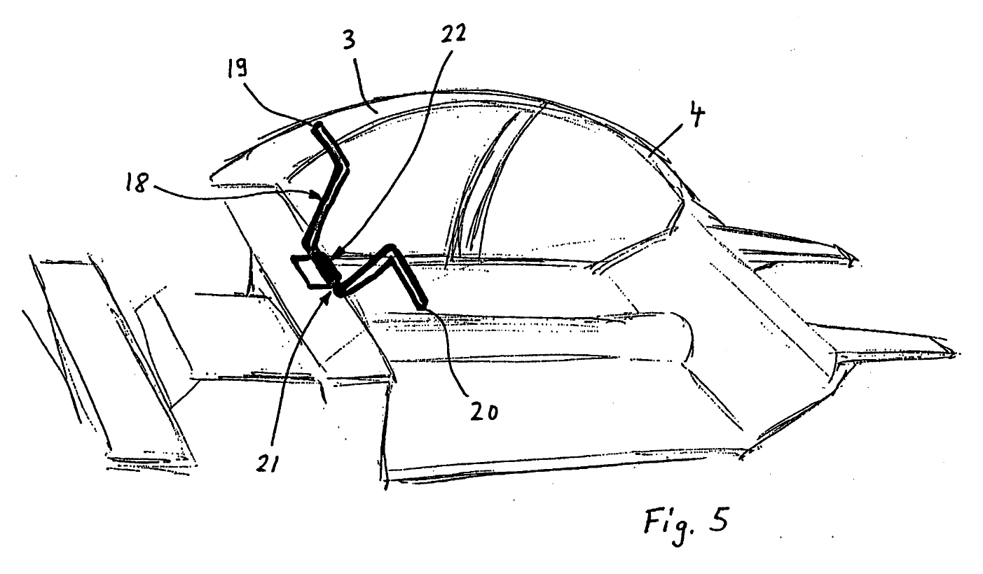

FIG. 5 shows in a perspective overhead view the body structure of the vehicle with the protective means shown in FIG. 4;

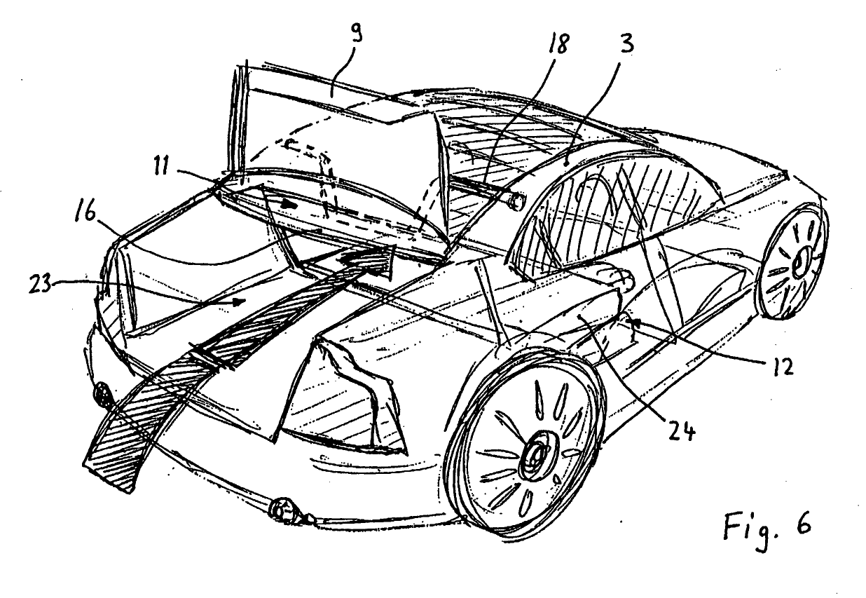

FIG. 6 shows in a perspective overhead view the vehicle with the protective means of FIGS. 4 and 5; and

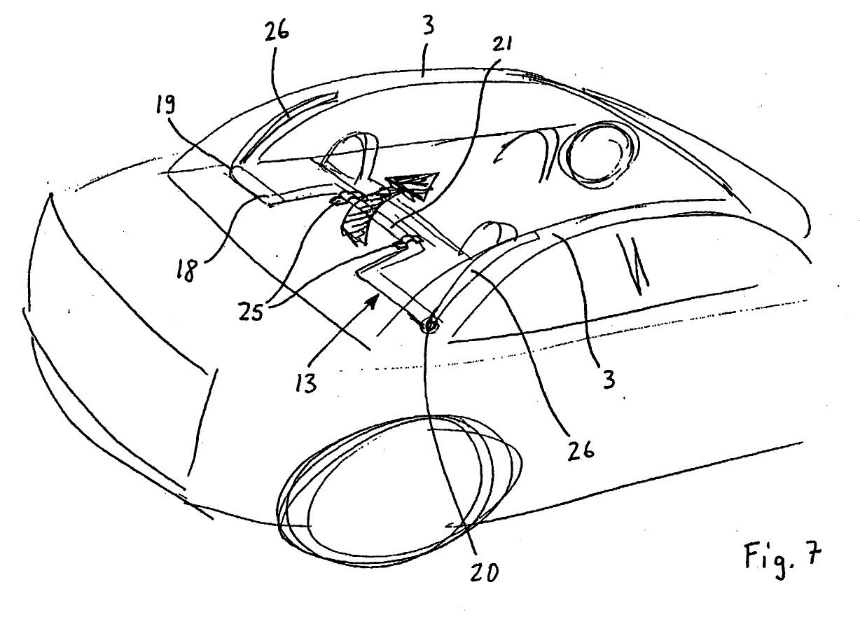

FIG. 7 shows in a perspective overhead view the motor vehicle with another embodiment of the protective means.

A motor vehicle 1 (see FIG. 1), in the embodiment a four-seat or five-seat limousine, for example with a fastback in the manner of a coupe, has a vehicle roof 2 with two lengthwise roof members 3 which adjoin the A columns 4 forward and pass in the rear into the C columns 5 or assume their function. Between the two lengthwise roof members 3 a roof opening 6 extends and can be selectively closed or at least partially cleared by the roof closing means in the form of a louvered roof 7 with individual louvers 8 of glass. The basic structure of a louvered roof is described for example in DE 196 08 916 C1 or EP 0 978 400 A2, to which reference is hereby made. The roof opening 6 extends between the lengthwise roof members 3 or the C columns 5 to the rear as far as the trunk lid 9. The louvers 8 are supported to be movable on one guide rail on each side at a time and are supported to be raisable with their rear edge 10.

To open the louvered roof 7 and to clear the roof opening 6, the louvers 8 are pushed to the rear by a drive means and are stacked on one another in their raised arrangement and thus stored in a space-saving manner in packet form on the end of the roof opening 6 (FIG. 1). Depending on the configuration of the motor vehicle roof 2 or the lengthwise roof members 3, they are located for example roughly over the hat rest 11 (position indicated by the broken-line arrow in FIG. 1) behind the back seats 12 (see also FIG. 2). In this lowered position, storage space is not required either in the vehicle interior or in the trunk space.

A long roof opening 6 is enabled since a conventional rear window is also formed by the movable louvers 8 of the louvered roof 7 and thus is divided and can be lowered in a space-saving manner. Since only the lengthwise roof members 3 laterally border the roof opening 6 and the lowered louvers 8 are located on the back end of the long roof opening 6, the passengers with the roof opened acquire the impression of a semi- or quasi-cabriolet.

But since the two lengthwise roof members 3 do not have a fixed, stiffening mutual connection in the area between the top front window frame and the rear transition to the body structure, the motor vehicle contains a rollover protection means 13 on the back end of the passenger compartment behind the seats or back seats. According to the first embodiment the protective means 13 (see FIG. 2) contains two stiff, angled or bent rods, pipes, or bows 14 which are attached with the bottom end 15 to the transverse bracing 16 of the body in the area of the hat rest 11 behind the back seats 12 (see also FIG. 3) and are permanently connected by the upper end 17 which is bent out to the respective lengthwise roof member 3. The two bows 14 are located such that they extend over the head area of the back seat passengers when looking in the lengthwise direction of the motor vehicle and in case of a rollover counteract the buckling of the lengthwise roof member 3. The bottom ends 15 of the bows 14 can extend down behind the backrests of the back seats 12 as far as the lower part of the body structure and can be attached there in addition to increase the strength.

A second embodiment of the protective means is formed as an elbowed rod 18 which is permanently attached with its two outer ends 19 and 20 to the respective lengthwise roof member 3, for example to the attachment position of the preceding embodiment. The middle part 21 of the rod 18 is elbowed down and is permanently mounted on the transverse bracing 16 of the body in the area of the hat rest 11 behind the back seats 12, for example with a clamp 22. This rod 18 forms a simple, but very effective mutual support of the two lengthwise roof members 3 as protection against buckling and in addition direct protection for the back seat passengers in the sense of a roll bar. Since the middle part 21 of the rod 18 rests for example on the transverse bracing 16 or is only slightly lowered, a through-loading possibility remains under the transverse bracing 16 and the hat rest 11, so that a trunk space 23 which is lengthened towards the vehicle interior with the rear seat backs 23 folded down can be used (see FIG. 6).

Another embodiment of the protective means as claimed in the invention (FIG. 7) likewise contains an elbowed bent rod 18 in the manner of the aforementioned example, but the middle part 21 is supported to be able to swivel around the transverse axis by means of a swivel support 25 on the transverse bracing 16. The two outside ends 19 and 20 are guided on the respective lengthwise roof member 3 in the arc-shaped guides 26. In the rest position the rod 18 is swivelled down onto the hat rest 11 or the transverse bracing 16 and is partially or entirely sunken thereon for example in a corresponding depression. With danger of a rollover a drive means for swivelling up the rod 18 is actuated by a signal of the corresponding sensor. The drive means contains for example a pyrotechnic charge or a spring force storage device. In the swivelled-up position the rod 18 (the arrangement corresponds roughly to FIG. 4) is kept interlocked and can thus support the two lengthwise roof members 3 against one another.

Corresponding protective means can of course also be used for two-seat vehicles such as for example a two-seat coupe.

The protective means thus offers additional safety in a semi-cabriolet, in which the two lengthwise roof members 3 are formed between their front coupling to the apron 28 which runs above the front window 27 and their respective rear coupling to the rear vehicle structure without the connecting structural bracing which is located in the roof surface, especially in the area of the B column 29.

Reference Number List

1 motor vehicle

2 motor vehicle roof

3 lengthwise roof member

4 A column

5 C column

6 roof opening

7 louvered roof

8 louver

9 trunk lid

10 rear edge

11 hat rest

12 back seat

13 rollover protection means

14 bow, bar

15 lower end

16 transverse bracing

17 top end

18 rod

19 outer end

20 outer end

21 middle part

22 clamp

23 trunk space

24 rear seat back

25 swivelling support

26 guide

27 front window

28 apron

29 B column

1. Motor vehicle, especially a limousine or a coupe, with a vehicle roof with body-mounted lengthwise roof members, with a roof opening between the lengthwise roof members and with a cover arrangement which is supported to be able to move on the lengthwise roof members for selectively closing or at least partially clearing the roof opening, and the cover arrangement can be lowered in the rear area with the roof opening cleared, characterized in that there is a rollover protection means (13) on the back end of the passenger compartment behind the seats or the rear seats (12).

2. Motor vehicle as claimed in claim 1, wherein the rollover protection means (13) has at least one rollover protection bar (14, 18).

3. Motor vehicle as claimed in claim 2, wherein the protective bar is formed for example as a U-shaped bar and is supported with its two ends on a structural body part (16) in the area of the hat rest (11).

4. Motor vehicle as claimed in claim 1 or 2, wherein the protective bar (14) is attached on the one hand to a structural body part behind the seats and on the other hand to the lengthwise roof member (3).

5. Motor vehicle as claimed in claim 5, wherein the protective bar (14) is bent or angled.

6. Motor vehicle as claimed in one of claims 2 to 5, wherein there is one protective bar each behind the respective seat.

7. Motor vehicle as claimed in claim 1 or 2, wherein the protective bar (18) is securely connected on its two ends (19, 20) to the respective lengthwise roof member (3) and is attached to the body structure (16) with its elbowed middle part (21).

8. Motor vehicle as claimed in one of claims 3 to 7, wherein the structural body part (16) has transverse bracing (16) in the area of the hat rest (11).

9. Motor vehicle as claimed in one of claims 1 to 8, wherein the protective bar (18) can be swinged out of its lowered position into its protective position.

10. Motor vehicle as claimed in claim 9, wherein the protective bar (18) is mounted for example on its elbowed middle part (21) on the structural body part (16) to be able to swivel around a transverse axis and wherein its two ends (19, 20) are each movably supported on the guide (26) of the respective lengthwise roof member (3.

11. Motor vehicle as claimed in claim 10, wherein there is a drive means for extending the protective bar (18) into its active position.

12. Motor vehicle as claimed in one of claims 1 to 11, wherein the two lengthwise roof members (3) are formed between their respective front coupling to the apron (28) which runs above the front window (27) and their respective rear coupling to the rear vehicle structure especially in the area of one B column (29) without the connecting structural bracing which is located in the roof surface.

13. Motor vehicle as claimed in one of claims 1 to 12, wherein the cover arrangement consists of louvers (8) of a louvered roof (7) and the louvers (8) are especially transparent glass louvers.
